(19) United States
(12) Patent Application Publication
(10) Pub. No.: US 2026/0330983 A1
(43) Pub. Date: Oct. 22, 2026

(54) METHOD AND APPARATUS FOR MONITORING TRAJECTORY CONFORMANCE OF ADVANCED AIR MOBILITY

(71) Applicant: SK TELECOM CO., LTD., Seoul (KR)

(72) Inventor: Jeongseok KIM, Seoul (KR)

(21) Appl. No.: 19/121,355

(22) PCT Filed: Sep. 26, 2023
(86) PCT No.: PCT/KR2023/014890

§ 371 Date: Apr. 15, 2025

(30) Foreign Application Priority Data
Oct. 26, 2022 (KR) 10-2022-0139160

(51) Int. Cl. G08G 5/72

(52) U.S. Cl. CPC G08G 5/72

(57) ABSTRACT

The present disclosure relates to method for monitoring trajectory conformance of advanced air mobility (AAM) by an electronic device including a memory and a processor, the method comprising: obtaining information on scheduled airspace segments the AAM is scheduled to pass through among a plurality of airspace segments within airways, based on a flight plan of the AAM; and obtaining information on an actual operating segment the AAM actually passed through among the plurality of airspace segments, based on a flight path of the AAM, and monitoring trajectory conformance of the AAM by comparing the information on the actual operating segment with the information on the scheduled airspace segments.

### CROSS REFERENCE TO RELATED APPLICATION

This application is National Stage of International Application No. PCT/KR2023/014890, filed on Sep. 26, 2023, which designates the United States and was published in Korea, and which is based upon and claims priority to Korean Patent Application No. 10-2022-0139160, filed on Oct. 26, 2022, in the Korean Patent Office. All of the aforementioned applications are hereby incorporated by reference in their entireties.

### TECHNICAL FIELD

The present invention relates to a method and apparatus for monitoring the trajectory conformance of advanced air mobility (AAM).

This study is related to the development of urban air mobility virtual integrated operation and verification technology (No. 1615012948), a research project which was conducted with the support of the Korea Agency for Infrastructure Technology Advancement (KAIA), funded by the Ministry of Land, Infrastructure and Transport (government) in 2022.

### BACKGROUND ART

AAM refers to the advanced air mobility, utilizing the sky as a transportation route by combining vertical take-off and landing (VTOL) capable personal air vehicles (PAV).

AAM, as a next-generation mobility solution that maximizes transportation efficiency in urban areas, has emerged to address issues such as the decline in mobility efficiency due to congestion in urban traffic, rising social costs like logistics transportation expenses, and other related challenges. With long-distance travel times increasing and traffic jams getting worse, AAM is seen as a solution to these problems while also being regarded as a future innovation business.

The airways operated by AAM are scheduled to be set between altitudes of 300 m and 600 m, and will be managed under the control of urban air traffic management (UATM). Separately, regions of an altitude of 300 m or higher are within the region of the existing air traffic management (ATM) and are under the control of the existing air vehicle control systems. That is, the airspace of 300 m or higher is a mixed control region of UATM and ATM. When AAM moves out of the UATM control region, the AAM needs to immediately be under the control of ATM.

In order to ensure that AAM operates normally within the airways and is under the control of UATM, and to ensure that it follows the optimal route within the airways and completes the flight according to the planned schedule, it is necessary to monitor and evaluate the flight trajectory of AAM.

However, since AAM differs from traditional aircraft in terms of purpose, flight environment, speed, and the size of the airways, the method for monitoring the flight trajectory of AAM becomes a challenge.

### DISCLOSURE

### Technical Problem

The problem to be solved by the present invention is to provide a method for monitoring trajectory conformance of AAM by using information on the scheduled airspace segments that AAM is scheduled to pass through and information on the actual operating segments that AAM has passed through, in combination with the information on the scheduled airspace segments.

However, the problem to be solved by the present invention is not limited to that mentioned above, and other problems to be solved that are not mentioned may be clearly understood by those of ordinary skill in the art to which the present invention belongs from the following description.

### Technical Solution

In accordance with one aspect of the present disclosure, there is provided a method for monitoring trajectory conformance of advanced air mobility (AAM) by an electronic device including a memory and a processor, the method comprising: obtaining information on scheduled airspace segments through which the AAM is scheduled to pass, selected among a plurality of airspace segments within airways based on a flight plan of the AAM; and obtaining information on actual operating segments through which the AAM actually passed, determined among the plurality of airspace segments based on a flight path of the AAM, and monitoring trajectory conformance of the AAM by comparing the information on the actual operating segments with the information on the scheduled airspace segments.

Preferably, the information on the scheduled airspace segments includes identification information on each of the scheduled airspace segments, an expected entry points of time when the AAM is expected to enter each of the scheduled airspace segments, and an expected exit points of time when the AAM is expected to exit each of the scheduled airspace segments.

Preferably, the monitoring the trajectory conformance of the AAM includes: determining whether identification information on the actual operating segments matches identification information on the scheduled airspace segments; comparing actual entry points of time when the AAM entered the actual operating segments with an expected entry points of time for the scheduled airspace segments to determine whether a difference between an actual entry point of time when the AAM entered each of the actual operating segments and an expected entry point of time for each of the scheduled airspace segments falls within a preset entry error; comparing actual exit points of time when the AAM exited the actual operating segments with expected exit points of time for the scheduled airspace segments to determine whether a difference between an actual exit point of time when the AAM exited each of the actual operating segments and an expected exit point of time for each of the scheduled airspace segments falls within a preset exit error; and monitoring the trajectory conformance of the AAM for the actual operating segments based on the determination of the matching of the identification information on the actual operating segments with the identification information on the scheduled airspace segments, the determination of whether the actual entry point of time falls within the entry error, and the determination of whether the actual exit point of time falls within the exit error.

Preferably, the monitoring the trajectory conformance of the AAM for the actual operating segment includes: evaluating that a route of the actual operating segments is consistent when it is determined that the identification information on the actual operating segments matches the identification information on the scheduled airspace segments, the difference between the actual entry point of time when the AAM entered each of the actual operating segments and the expected entry point of time for each of the scheduled airspace segments falls within the entry error, and the actual exit point of time falls within the exit error from the expected exit point of time.

Preferably, the monitoring the trajectory conformance of the AAM for the actual operating segment includes: evaluating that a route of the actual operating segments is inconsistent when it is determined that identification information on the actual operating segments does not match identification information on the scheduled airspace segments, the difference between the actual entry point of time when the AAM entered each of the actual operating segments and the expected entry point of time for each of the scheduled airspace segments does not fall within the entry error, or the difference between the actual entry point of time when the AAM entered each of the actual operating segments and the expected entry point of time for each of the scheduled airspace segments does not fall within the exit error.

Preferably, the monitoring the trajectory conformance of the AAM further includes: determining whether the actual operating segments fall within a route conformance region, and the evaluating the route of the actual operating segment being inconsistent has: evaluating the inconsistency further based on the determination of whether the actual operating segments fall within the route conformance region.

Preferably, a weight is assigned based on whether the actual operating segments fall within the route conformance region, and a weight in a state where the actual operating segments do not fall within the route conformance region is set to be larger than a weight in a state where the actual operating segments fall within the route conformance region.

Preferably, the monitoring the trajectory conformance of the AAM includes: identifying the actual operating segments as the airspace segments of a structure that includes a second airspace segment, in a state where the plurality of airspace segments have a first airspace segment of a predetermined size and the second airspace segment of a size smaller than the predetermined size, the second airspace segment is arranged within a partial region of the first airspace segment, and the second airspace segment is set as one of the scheduled airspace segments; and providing a preset value as a value for monitoring the trajectory conformance of the AAM, based on identifying the actual operating segments as the first airspace segments of the structure that has the second airspace segment.

Preferably, the method further comprises: comparing, when there is at least one actual operating segment, a first score, which is a sum of scores assigned to the scheduled airspace segments, with a second score, which is a sum of scores assigned to the actual operating segments, respectively, based on results of monitoring the trajectory conformance for each actual operating segment; and determining whether the AAM's operation is normal based on whether a difference between the first score and the second score is within a preset threshold difference.

Preferably, the determining whether the AAM's operation is normal includes: determining whether the AAM's operation is normal up to a predetermined point of time when the actual operating segment corresponds to at least one airspace segment that the AAM passed through up to the predetermined point of time during the AAM's operation.

In accordance with another aspect of the present disclosure, an apparatus for monitoring trajectory conformance, comprising: a memory storing a trajectory conformance monitoring program for monitoring trajectory conformance of advanced air mobility (AAM); and a processor configured to control the memory, wherein the processor configured to: obtain information on scheduled airspace segments through which the AAM is scheduled to pass, among a plurality of airspace segments within airways based on a flight plan of the AAM; obtain information on actual operating segments through which the AMM actually passed, among the plurality of airspace segments based on a flight path of the AAM; and monitor the trajectory conformance by comparing the information on actual operating segments with the information on the scheduled airspace segments.

In accordance with a still another aspect of the present disclosure, there is provided a computer program stored a non-transitory computer-readable recording medium, wherein the computer program including instructions for, when executed by a processor, causing the processor to perform method for monitoring trajectory conformance of advanced air mobility (AAM) by an electronic device including a memory and a processor, the method comprising: obtaining information on scheduled airspace segments through which the AAM is scheduled to pass, selected among a plurality of airspace segments within airways based on a flight plan of the AAM; and obtaining information on actual operating segments through which the AAM actually passed, determined among the plurality of airspace segments based on a flight path of the AAM, and monitoring trajectory conformance of the AAM by comparing the information on the actual operating segments with the information on the scheduled airspace segments.

In accordance with a still another aspect of the present disclosure, there is provided a non-transitory computer-readable recording medium storing a computer program, wherein the computer program including instructions for, when executed by a processor, causing the processor to perform method for monitoring trajectory conformance of advanced air mobility (AAM) by an electronic device including a memory and a processor, the method comprising: obtaining information on scheduled airspace segments through which the AAM is scheduled to pass, selected among a plurality of airspace segments within airways based on a flight plan of the AAM; and obtaining information on actual operating segments through which the AAM actually passed, determined among the plurality of airspace segments based on a flight path of the AAM, and monitoring trajectory conformance of the AAM by comparing the information on the actual operating segments with the information on the scheduled airspace segments.

### Advantageous Effects

According to an embodiment of the present invention, by using information on the scheduled airspace segments that AAM is scheduled to pass through and information on the actual operating segments that AAM passed through along with the information on the scheduled airspace segments, the trajectory conformance of AAM can be monitored. This enables an accurate and fast evaluation of the trajectory conformance of AAM.

According to an embodiment of the present invention, by monitoring the trajectory conformance of AAM not only after AAM's operation is completed but also during AAM's operation, it is possible to provide real-time warnings for any abnormal operation of AAM.

### DESCRIPTION OF DRAWINGS

FIG. 1 is a block diagram illustrating an apparatus for monitoring trajectory conformance according to an embodiment.

FIG. 2 is a block diagram conceptually illustrating the functions of a trajectory conformance monitoring program according to an embodiment.

FIG. 3 is a view for describing a route conformance region.

FIG. 4 is an example for describing how a trajectory conformance monitoring unit processes trajectory conformance monitoring based on various shapes and sizes of a plurality of airspace segments.

FIG. 5 is an example illustrating how the trajectory conformance monitoring unit assigns scores to each aircraft based on the actual route of the aircraft.

FIG. 6 is a flowchart illustrating how the trajectory conformance monitoring program monitors the trajectory conformance of an aircraft according to an embodiment.

### MODE FOR DISCLOSURE

The advantages and features of embodiments and methods of accomplishing these will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing the embodiments of the present disclosure, if it is determined that detailed description of related known components or functions unnecessarily obscures the gist of the present disclosure, the detailed description thereof will be omitted. Further, the terminologies to be described below are defined in consideration of functions of the embodiments of the present disclosure and may vary depending on a user's or an operator's intention or practice. Accordingly, the definition thereof may be made on a basis of the content throughout the specification.

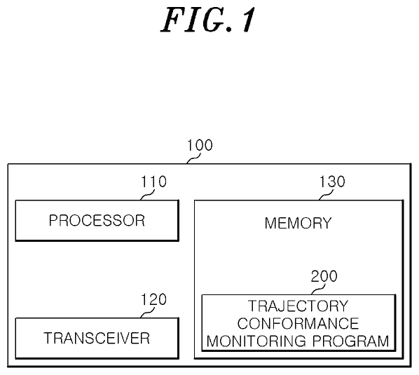

FIG. 1 is a block diagram illustrating an apparatus for monitoring trajectory conformance according to an embodiment.

A processor 110 may control the overall operation of an apparatus 100 for monitoring trajectory conformance.

The processor 110, using a transceiver 120, may receive information on the virtual space from an airspace segment management device (not illustrated).

For the convenience of description, this specification describes the apparatus 100 for monitoring trajectory conformance as receiving information on the airspace segment from the airspace segment management device (not illustrated), but is limited thereto. That is, depending on the embodiment, the apparatus 100 for monitoring trajectory conformance may receive information on the airspace segment from another device or system, or may generate information on the airspace segment within the apparatus 100 for monitoring trajectory conformance.

The memory 130 may store a trajectory conformance monitoring program 200 and information necessary for the execution of the trajectory conformance monitoring program 200.

In this specification, the trajectory conformance monitoring program 200 may refer to software including programmed instructions to monitor the trajectory conformance of aircraft such as advanced air mobility (AAM) and drones.

In addition, in this specification, a route (or operating path) may refer to a path (or route) that the aircraft is expected to pass through within the airways according to the flight plan of the aircraft, and the airways may refer to segments of the airspace where the aircraft may operate.

The processor 110 may load the trajectory conformance monitoring program 200 and the information necessary for the execution of the trajectory conformance monitoring program 200 from the memory 130 in order to execute the trajectory conformance monitoring program 200.

The processor 110 may execute the trajectory conformance monitoring program 200 to monitor the trajectory conformance of the aircraft.

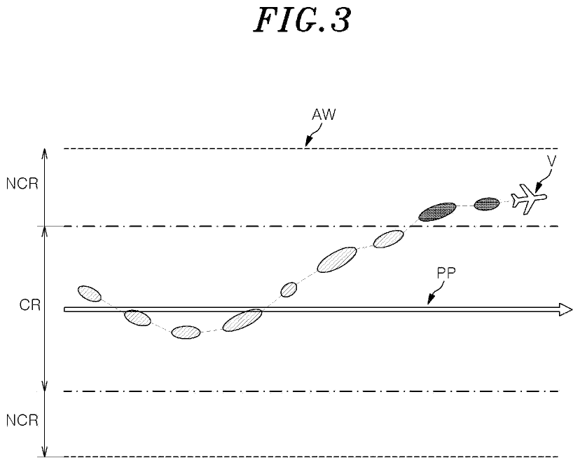

The functions and/or operations of the trajectory conformance monitoring program 200 will be described in detail with reference to FIG. 3.

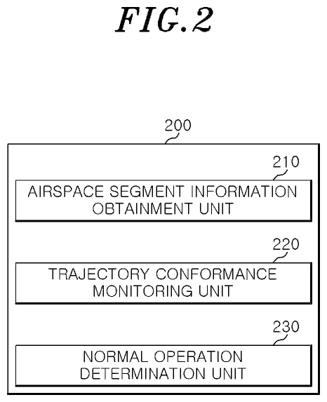

FIG. 2 is a block diagram conceptually illustrating the functions of a trajectory conformance monitoring program according to an embodiment.

With reference to FIG. 1 and FIG. 2, the trajectory conformance monitoring program 200 may include an airspace segment information obtainment unit 210, a trajectory conformance monitoring unit 220, and a normal operation determination unit 230.

The airspace segment information obtainment unit 210, trajectory conformance monitoring unit 220, and normal operation determination unit 230 illustrated in FIG. 2 are conceptually divided to explain the functions of the trajectory conformance monitoring program 200 easily, and are not limited thereto. According to embodiments, the function of each of the airspace segment information obtainment unit 210, trajectory conformance monitoring unit 220, and normal operation determination unit 230 may be merged or separated, and may be implemented by a series of instructions included in a single program.

The airspace segment information obtainment unit 210 may obtain information on the scheduled airspace segments, which represent information on the airspace segments the aircraft is scheduled to pass through among a plurality of airspace segments in the airways based on the aircraft's operating path, as well as information on the actual operating segments, which represent information on the airspace segments the aircraft has passed through or is currently passing through among the plurality of airspace segments in the airways based on the actual route of the aircraft.

According to an embodiment, the airspace segment information obtainment unit 210 may receive information on the scheduled airspace segments from an airspace segment management device (not illustrated) as the aircraft's operating path is determined.

According to an embodiment, the information on the scheduled airspace segments may include identification information on each scheduled airspace segment, an expected entry point of time when the aircraft is expected to enter each scheduled airspace segment, and an expected exit point of time when the aircraft is expected to exit each scheduled airspace segment.

According to an embodiment, the airspace segment information obtainment unit 210 may periodically receive information on the actual operating segments from the airspace segment management device (not illustrated) or the aircraft, and may also directly generate information on the actual operating segments using the aircraft's position information periodically received from the airspace segment management device (not illustrated) or the aircraft.

According to an embodiment, the information on the actual operating segment may include identification information on the actual operating segment, an actual entry point of time when the aircraft entered the actual operating segment, and an actual exit point of time when the aircraft exited the actual operating segment.

The trajectory conformance monitoring unit 220 may monitor the aircraft's trajectory conformance by comparing the information on the actual operating segment with the information on the scheduled airspace segments.

More specifically, the trajectory conformance monitoring unit 220 may determine whether the actual operating segment is included in the scheduled airspace segments, determine whether the actual entry point of time when the aircraft entered the actual operating segment falls within a preset entry error from the expected entry point of time when the aircraft was expected to enter the actual operating segment, and determine whether the actual exit point of time when the aircraft exited the actual operating segment falls within a preset exit error from the expected exit point of time when the aircraft was expected to exit the actual operating segment. The trajectory conformance monitoring unit 220 may monitor the aircraft's trajectory conformance for the actual operating segment based on the determination of whether the actual operating segment is included, the determination of whether the actual entry point of time falls within the entry error, and the determination of whether the actual exit point of time falls within the exit error.

According to an embodiment, the trajectory conformance monitoring unit 220 may determine whether the actual operating segment is included in the scheduled airspace segments based on the result of comparing the identification information on the actual operating segment with the identification information on each of the scheduled airspace segments. For example, when the identification information on the actual operating segment is the same as the identification information on any one of the scheduled airspace segments, the trajectory conformance monitoring unit 220 may determine that the actual operating segment is included in the scheduled airspace segments. Meanwhile, when the identification information on the actual operating segment differs from the identification information on the scheduled airspace segments, the trajectory conformance monitoring unit 220 may determine that the actual operating segment is not included in the scheduled airspace segments.

When it is determined that the actual operating segment is included in the scheduled airspace segments, the actual entry point of time falls within the entry error from the expected entry point of time, and the actual exit point of time falls within the exit error from the expected exit point of time, the trajectory conformance monitoring unit 220 may evaluate that the aircraft's detour possibility for the actual operating segment is consistent.

Meanwhile, it is determined that the actual operating segment is not included in the scheduled airspace segments, the actual entry point of time does not fall within the entry error from the expected entry point of time, or the actual exit point of time does not fall within the exit error from the expected exit point of time, the trajectory conformance monitoring unit 220 may evaluate that the aircraft's detour possibility for the actual operating segment is inconsistent.

According to an embodiment, the trajectory conformance monitoring unit 220 may perform the determination of whether the actual operating segment is included, the determination of whether the actual entry point of time falls within the entry error, and the determination of whether the actual exit point of time falls within the exit error either simultaneously or at different times.

According to an embodiment, when the determination of whether the actual operating segment is included, the determination of whether the actual entry point of time falls within the entry error, and the determination of whether the actual exit point of time falls within the exit error are performed at different times, the trajectory conformance monitoring unit 220 may not perform all of the determination of whether the actual operating segment is included, the determination of whether the actual entry point of time falls within the entry error, and the determination of whether the actual exit point of time falls within the exit error are performed at different times. For example, when it is determined that the actual operating segment is not included in the scheduled airspace segments, the trajectory conformance monitoring unit 220 may evaluate the aircraft's detour possibility for the actual operating segment as inconsistent without performing the determination of whether the actual entry point of time falls within the entry error and whether the actual exit point of time falls within the exit error.

When the trajectory conformance monitoring unit 220 evaluates the aircraft's detour possibility for the actual operating segment as consistent, it may assign a score greater than a predetermined reference score (e.g., a positive score of a predetermined size) to the actual operating segment. Conversely, when the trajectory conformance monitoring unit 220 evaluates the aircraft's detour possibility for the actual operating segment as inconsistent, it may assign a score smaller than the reference score (e.g., a negative score of a predetermined size) to the actual operating segment.

Meanwhile, according to an embodiment, the trajectory conformance monitoring unit 220 may monitor the trajectory conformance of the actual operating segment based on whether the actual operating segment corresponds to a route conformance region. That is, the trajectory conformance monitoring unit 220 may assign a score to the actual operating segment based on whether the actual operating segment corresponds to the route conformance region.

For example, when the trajectory conformance monitoring unit 220 evaluates the aircraft's detour possibility for the actual operating segment as inconsistent, the score assigned to the actual operating segment when the actual operating segment corresponds to the route non-conformance region may be smaller than the score assigned to the actual operating segment when the actual operating segment corresponds to the route conformance region. That is, the trajectory conformance monitoring unit 220 may set a weight (degree of route inconsistency) assigned to the actual operating segment when corresponding to the route conformance region to be smaller than a weight (degree of route inconsistency) assigned to the actual operating segment when corresponding to the route non-conformance region.

Here, the route conformance region may refer to an error region that does not completely match the route, but is sufficient to recognize that the aircraft is operating along the route. Therefore, the route non-conformance region may refer to the remaining regions that are not part of the route conformance region.

For example, FIG. 3 is a view for describing a route conformance region.

With further reference to FIG. 3, once an operating path PP of an aircraft V is determined according to the flight plan of the aircraft V, a route conformance region CR of a preset size may be set along the operating path PP within the airways AW.

The aircraft V may operate within the route conformance region CR. According to an embodiment, when the aircraft V deviates from the route conformance region CR (i.e., when the aircraft V enters the route non-conformance region NCR), the aircraft V or an operation control device (not illustrated) that controls the operation of the aircraft V may transmit a warning message to the UATMSP (AAM Air Traffic Management Service Provider), the operator, the pilot of the aircraft V, etc., indicating that the aircraft V has deviated from the route conformance region CR (i.e., indicating that the aircraft V has deviated from its route).

With reference back to FIG. 2, according to an embodiment, the trajectory conformance monitoring unit 220 may assign a score to the actual operating segment further based on the inclusion relationship between the actual operating segment and other airspace segments. For example, the plurality of airspace segments may be composed of various shapes and sizes. In addition, the airspace segments may be composed of a first size and a second size, where the first size is set to be larger than the second size.

Furthermore, the airspace segments of the first size may be configured to include airspace segments of the second size within the airspace segments of the first size. For example, when the airspace segment of the first size is referred to as a first airspace segment and the airspace segment of the second size is referred to as a second airspace segment, the second airspace segment may be configured to be positioned within a partial region of the first airspace segment. That is, the first airspace segment may be configured to include both the region where the second airspace segment exists and another region where the second airspace segment does not exist. Based on the above, the actual operating segment may correspond to the second airspace segment, or to another region within the first airspace segment where the second airspace segment does not exist. When the actual operating segment corresponds to the second airspace segment or to another region within the first airspace segment where the second airspace segment does not exist, and in case that the trajectory conformance monitoring result is calculated differently depending on which region within the first airspace segment the second airspace segment exists, the score for the entire operating path may become exaggerated, or the complexity of the trajectory conformance monitoring may increase. With this in consideration, the trajectory conformance monitoring unit 220 may identify whether the structure of the first airspace segment includes the second airspace segment. When the actual operating segment falls within the aforementioned structure, the trajectory conformance monitoring unit 220 may assign a preset value (e.g., “0 (zero) points”) as the value for monitoring trajectory conformance. That is, the trajectory conformance monitoring unit 220 may not monitor the aircraft's trajectory conformance when the actual operating segment is confirmed to be within the structure where the second airspace segment exists within the first airspace segment.

This is because, in the aforementioned structure where the first airspace segment includes both the region where the second airspace segment exists and another region where the second airspace segment does not exist, when the trajectory conformance is monitored by distinguishing between the region where the second airspace segment exists and the region where the second airspace segment does not, the score for the entire operating path of the aircraft may become exaggerated, or the complexity of the trajectory conformance monitoring may increase. Therefore, when the actual operating segment corresponds to being within an airspace segment of the aforementioned structure, the trajectory conformance monitoring unit 220 may assign a preset value (e.g., “0 (zero) points”) as the value for monitoring trajectory conformance, in order to prevent the trajectory conformance of the actual operating segment from affecting the trajectory conformance of the entire path.

The normal operation determination unit 230 may determine the normality of the aircraft's operation based on the result of evaluating the aircraft's trajectory conformance.

More specifically, the normal operation determination unit 230 may compare a first score assigned to the scheduled airspace segments that the aircraft was scheduled to pass through according to the aircraft's operating path with a second score assigned to at least one actual operating segment the aircraft passed through according to the aircraft's actual route. Based on the result of this comparison, the normal operation determination unit 230 may determine whether the aircraft's operation is a normal operation.

According to an embodiment, the normal operation determination unit 230 may determine whether a difference between the first score and the second score is within a preset threshold difference, and based on this determination, determine whether the aircraft's operation is a normal operation.

For example, the normal operation determination unit 230 may determine that the aircraft's operation is normal when the difference between the first score and the second score is within the threshold difference. Meanwhile, the normal operation determination unit 230 may determine that the aircraft's operation is abnormal when the difference between the first score and the second score is greater than the threshold difference.

According to an embodiment, the normal operation determination unit 230 may determine the normality of the aircraft's operation after the aircraft's operation has been completed, reflecting the entire actual route of the aircraft. However, it may also determine the normality of the aircraft's operation in real-time while the aircraft is operating.

For example, the normal operation determination unit 230 may compare the first score assigned to the scheduled airspace segments the aircraft was scheduled to pass through up to the current point of time, according to the aircraft's operating path, with the second score assigned to the actual operating segments the aircraft has passed through up to the current point of time, based on the aircraft's actual route. Based on the result of this comparison, the normal operation determination unit 230 may determine whether the aircraft's operation is a normal operation. According to an embodiment, when the aircraft's operation is determined to be abnormal, the normal operation determination unit 230 may notify the aircraft, the operation control device (not illustrated), and the like about the abnormality of the aircraft's operation.

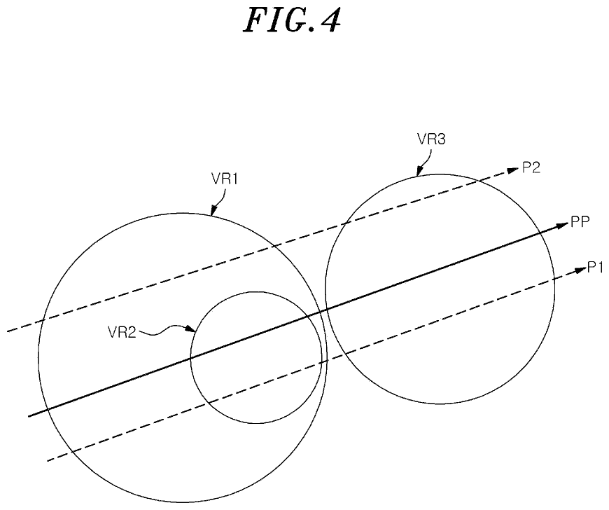

FIG. 4 is an example for describing how a trajectory conformance monitoring unit processes trajectory conformance monitoring based on various shapes and sizes of a plurality of airspace segments.

With reference to FIG. 2 and FIG. 4, a first airspace segment VR1 may include a second airspace segment VR2 and be positioned adjacent to a third airspace segment VR3 without overlapping any part of the third airspace segment VR3. A size of the first airspace segment VR1 may be set to be larger than a size of the second airspace segment VR2, and the second airspace segment VR2 may be configured to exist within a partial region of the first airspace segment VR1. Accordingly, the first airspace segment VR1 may include both the region where the second airspace segment VR2 exists and the region where the second airspace segment VR2 does not exist.

In the aforementioned structure of the airspace segments, when the operating path PP is preset for the aircraft to pass through the first airspace segment VR1, the second airspace segment VR2, and the third airspace segment VR3, when the aircraft actually operates along the first route P1, the aircraft may pass through the second airspace segment VR2 as planned in the operating path. In contrast, when the aircraft actually operates along the second route P2, the aircraft may pass through the first airspace segment VR1, but not pass through the second airspace segment VR2. Instead, the aircraft may pass through the region where the second airspace segment VR2 does not exist, differing from the planned operating path.

However, in order to prevent the score for the entire operating path of the aircraft from becoming exaggerated or the complexity of the trajectory conformance monitoring from increasing, the trajectory conformance monitoring unit 220 may assign a preset value (e.g., “0 (zero) points”) as the value for monitoring trajectory conformance. Therefore, the trajectory conformance monitoring unit 220 may evaluate that both the first route P1 and the second route P2 within the first airspace segment VR1 are consistent with the operating path.

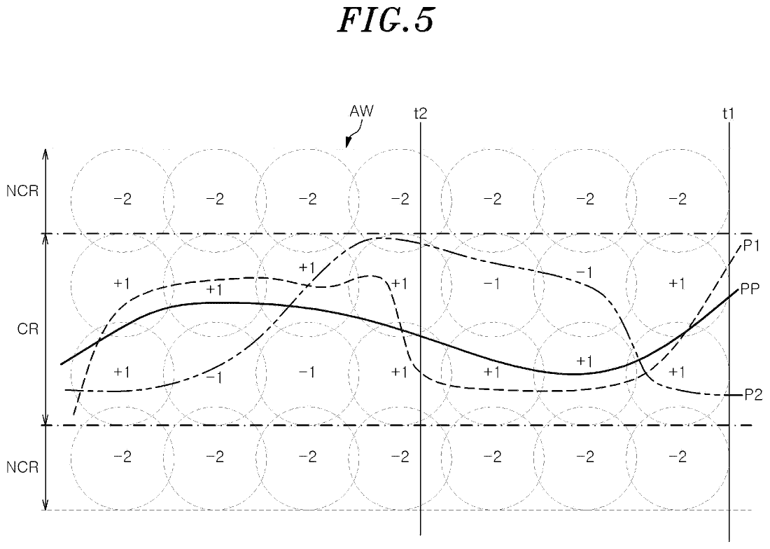

FIG. 5 is an example illustrating how the trajectory conformance monitoring unit assigns scores to each aircraft based on the actual route of the aircraft.

With reference to FIG. 2 and FIG. 5, when the route conformance region CR is set according to the aircraft's operating path PP, the airspace segments positioned in the route non-conformance region NCR among the plurality of airspace segments in the airways AW may be set a higher weight (e.g., twice as much) than the airspace segments positioned in the route conformance region CR among the plurality of airspace segments.

Therefore, when a +1 point is assigned to the airspace segments that the aircraft is scheduled to pass through among the airspace segments positioned the route conformance region CR, and a −1 point is assigned to the airspace segments that the aircraft is not scheduled to pass through among the airspace segments positioned the route conformance region CR, the airspace segments positioned in the route non-conformance region NCR may be assigned a −2 points.

Meanwhile, in FIG. 5, for the convenience of description, only whether the airspace segment the aircraft has passed through according to the aircraft's actual route is included in the airspace segments the aircraft is scheduled to pass through according to the aircraft's operating path is considered, and the entry point of time and exit point of time are not taken into account.

Among the virtual spaces illustrated in FIG. 5, since there are five airspace segments the aircraft is scheduled to pass through by a first point of time t1, the first score assigned to the airspace segments the aircraft is scheduled to pass through by the first point of time t1 may be determined as +5 points.

In this case, when the aircraft operated along the first route P1 up to the first point of time t1, the airspace segments the aircraft actually passed through are the same as the airspace segments the aircraft was scheduled to pass through (i.e., since the aircraft passed through all 5 of the airspace segments scheduled to pass through). Therefore, the trajectory conformance monitoring unit 220 may assign +5 points to the second score used to determine the aircraft's trajectory conformance.

In contrast, when the aircraft operated along the second route P2 up to the first point of time t1, the aircraft passes through 3 of the airspace segments the aircraft was scheduled to pass through (+3 points). However, the aircraft passed through one airspace segment that the aircraft was not scheduled to pass through, among the airspace segments positioned in the route conformance region CR (−1 point), and one airspace segment positioned in the route non-conformance region NCR (−2 points). Therefore, the trajectory conformance monitoring unit 220 may assign 0 points as the second score for determining the aircraft's trajectory conformance up to the first point of time t1.

Therefore, when the aircraft operated along the first route P1, the difference between the first score and the second score is within the threshold difference. As a result, the normal operation determination unit 230 may determine that the aircraft's operation up to the first point of time t1 is normal. In contrast, when the aircraft operated along the second route P2, and the difference between the first score and the second score is greater than the threshold difference, the normal operation determination unit 230 may determine that the aircraft's operation up to the first point of time t1 is abnormal.

Additionally, among the airspace segments illustrated in FIG. 5, since there are 10 airspace segments the aircraft is scheduled to pass through by a second point of time t2, the first score assigned to the airspace segments the aircraft is scheduled to pass through by the second point of time t2 may be determined as +10 points.

In this case, when the aircraft operated along the first route P1 up to the second point of time t2, the airspace segments the aircraft actually passed through are the same as the airspace segments the aircraft was scheduled to pass through (i.e., since the aircraft passed through all 10 of the airspace segments scheduled to pass through). Therefore, the trajectory conformance monitoring unit 220 may assign +10 points to the second score used to determine the aircraft's trajectory conformance.

In contrast, when the aircraft operated along the second route P2 up to the second point of time t2, the aircraft passes through 4 of the airspace segments the aircraft was scheduled to pass through (+4 points). However, the aircraft passed through three airspace segments that the aircraft was not scheduled to pass through, among the airspace segments positioned in the route conformance region CR (−3 point), and one airspace segment positioned in the route non-conformance region NCR (−2 points). Therefore, the trajectory conformance monitoring unit 220 may assign −1 points as the second score for determining the aircraft's trajectory conformance up to the second point of time t2.

Therefore, when the aircraft operated along the first route P1, the difference between the first score and the second score is within the threshold difference. As a result, the normal operation determination unit 230 may determine that the aircraft's operation up to the second point of time t2 is normal. In contrast, when the aircraft operated along the second route P2, and the difference between the first score and the second score is greater than the threshold difference, the normal operation determination unit 230 may determine that the aircraft's operation up to the second point of time t2 is abnormal.

That is, as seen through FIG. 5, the trajectory conformance monitoring unit 220 may monitor the aircraft's trajectory conformance after the aircraft's operation has been all completed. However, the trajectory conformance monitoring unit 220 may also determine in real-time, during the operation, whether the airspace segments the aircraft has passed through are the same as the airspace segments the aircraft was scheduled to pass through according to the operating path, and monitor the aircraft's trajectory conformance accordingly. Accordingly, the normal operation determination unit 230 may determine the normality of the aircraft's operation either after the aircraft's operation has been all completed or during the aircraft's operation.

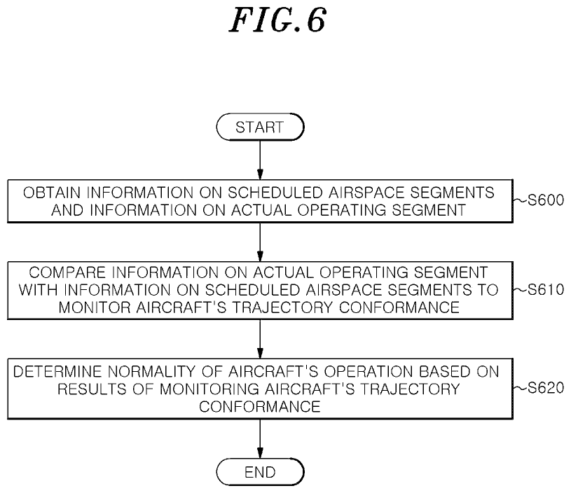

FIG. 6 is a flowchart illustrating how the trajectory conformance monitoring program monitors the trajectory conformance of an aircraft according to an embodiment.

With reference to FIG. 2 and FIG. 6, the airspace segment information obtainment unit 210 may obtain information on the first airspace segments, which represent information on the airspace segments the aircraft is scheduled to pass through among a plurality of airspace segments in the airways based on the aircraft's operating path, as well as information on the second airspace segments, which represent information on the virtual space the aircraft has passed through or is currently passing through among the plurality of airspace segments in the airways based on the actual route of the aircraft (S600).

The trajectory conformance monitoring unit 220 may monitor the aircraft's trajectory conformance by comparing the information on the second airspace segment with the information on the first airspace segments (S610).

The normal operation determination unit 230 may determine the normality of the aircraft's operation based on the result of evaluating the aircraft's trajectory conformance (S620).

According to an embodiment of the present invention, by using the information on the first airspace segments that AAM is scheduled to pass through and the information on the second airspace segments that AAM has passed through, the trajectory conformance of AAM may be monitored. This allows for an accurate and fast evaluation of AAM's trajectory conformance.

According to an embodiment of the present invention, by monitoring the trajectory conformance of AAM not only after AAM's operation is completed but also during AAM's operation, it is possible to provide real-time warnings for any abnormal operation of AAM.

Combinations of each block of the block diagrams and each step of the flowchart attached to the present disclosure may be performed by computer program instructions. Since these computer program instructions can be installed in an encoding processor of a general-purpose computer, a special-purpose computer, or other programmable data processing equipment, the instructions executed through the encoding processor of the computer or other programmable data processing equipment generate means for executing functions described in each block of the block diagrams or each step of the flowchart. These computer program instructions may also be stored in a computer-usable or computer-readable memory that can be directed to computers or other programmable data processing equipment to implement functions in a particular way, and thus the instructions stored in the computer-usable or computer-readable memory can also produce manufactured items containing instruction means for executing the functions described in each block of the block diagram or each step of the flowchart. Since the computer program instructions can also be installed in a computer or other programmable data processing equipment, a series of operational steps may be performed on the computer or other programmable data processing equipment to create a process that is executed by the computer, thereby providing steps for executing the functions described in each block of the block diagrams and each step of the flowchart through the instructions.

Additionally, each block or each step may represent a module, a segment, or some code that includes one or more executable instructions for executing specified logical function(s). Additionally, it should be noted that, in some alternative embodiments, the functions mentioned in blocks or steps are executed out of order. For example, two blocks or steps shown in succession may be performed substantially simultaneously, or the blocks or steps may sometimes be performed in reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

1. A method for monitoring trajectory conformance of advanced air mobility (AAM) by an electronic device including a memory and a processor, the method comprising:
obtaining information on scheduled airspace segments through which the AAM is scheduled to pass, selected among a plurality of airspace segments within airways based on a flight plan of the AAM; and
obtaining information on actual operating segments through which the AAM actually passed, determined among the plurality of airspace segments based on a flight path of the AAM, and monitoring trajectory conformance of the AAM by comparing the information on the actual operating segments with the information on the scheduled airspace segments.

2. The method of claim 1, wherein the information on the scheduled airspace segments includes identification information on each of the scheduled airspace segments, an expected entry points of time when the AAM is expected to enter each of the scheduled airspace segments, and an expected exit points of time when the AAM is expected to exit each of the scheduled airspace segments.

3. The method of claim 1, wherein the monitoring the trajectory conformance of the AAM includes:
determining whether identification information on the actual operating segments matches identification information on the scheduled airspace segments;
comparing actual entry points of time when the AAM entered the actual operating segments with an expected entry points of time for the scheduled airspace segments to determine whether a difference between an actual entry point of time when the AAM entered each of the actual operating segments and an expected entry point of time for each of the scheduled airspace segments falls within a preset entry error;
comparing actual exit points of time when the AAM exited the actual operating segments with expected exit points of time for the scheduled airspace segments to determine whether a difference between an actual exit point of time when the AAM exited each of the actual operating segments and an expected exit point of time for each of the scheduled airspace segments falls within a preset exit error; and
monitoring the trajectory conformance of the AAM for the actual operating segments based on the determination of the matching of the identification information on the actual operating segments with the identification information on the scheduled airspace segments, the determination of whether the actual entry point of time falls within the entry error, and the determination of whether the actual exit point of time falls within the exit error.

4. The method of claim 3, wherein the monitoring the trajectory conformance of the AAM for the actual operating segments includes:
evaluating that a route of the actual operating segments is consistent when it is determined that the identification information on the actual operating segments matches the identification information on the scheduled airspace segments, the difference between the actual entry point of time when the AAM entered each of the actual operating segments and the expected entry point of time for each of the scheduled airspace segments falls within the entry error, and the actual exit point of time falls within the exit error from the expected exit point of time.

5. The method of claim 3, wherein the monitoring the trajectory conformance of the AAM for the actual operating segments includes:
evaluating that a route of the actual operating segments is inconsistent when it is determined that identification information on the actual operating segments does not match identification information on the scheduled airspace segments, the difference between the actual entry point of time when the AAM entered each of the actual operating segments and the expected entry point of time for each of the scheduled airspace segments does not fall within the entry error, or the difference between the actual entry point of time when the AAM entered each of the actual operating segments and the expected entry point of time for each of the scheduled airspace segments does not fall within the exit error.

6. The method of claim 5, wherein the monitoring the trajectory conformance of the AAM further includes:
determining whether the actual operating segments fall within a route conformance region, and
wherein the evaluating of the route of the actual operating segments being inconsistent has:
evaluating the inconsistency further based on the determination of whether the actual operating segments fall within the route conformance region.

7. The method of claim 6, wherein a weight is assigned based on whether the actual operating segments fall within the route conformance region, and
wherein a weight in a state where the actual operating segments do not fall within the route conformance region is set to be larger than a weight in a state where the actual operating segments fall within the route conformance region.

8. The method of claim 1, wherein the monitoring the trajectory conformance of the AAM includes:
identifying the actual operating segments as the airspace segments of a structure that includes a second airspace segment, in a state where the plurality of airspace segments have a first airspace segment of a predetermined size and the second airspace segment of a size smaller than the predetermined size, the second airspace segment is arranged within a partial region of the first airspace segment, and the second airspace segment is set as one of the scheduled airspace segments; and
providing a preset value as a value for monitoring the trajectory conformance of the AAM, based on identifying the actual operating segments as the first airspace segments of the structure that has the second airspace segment.

9. The method of claim 1, further comprising:
comparing, when there is at least one actual operating segment, a first score, which is a sum of scores assigned to the scheduled airspace segments, with a second score, which is a sum of scores assigned to the actual operating segments, respectively, based on results of monitoring the trajectory conformance for each actual operating segment; and
determining whether the AAM's operation is normal based on whether a difference between the first score and the second score is within a preset threshold difference.

10. The method of claim 9, wherein the determining whether the AAM's operation is normal includes:
determining whether the AAM's operation is normal up to a predetermined point of time when the actual operating segment corresponds to at least one airspace segment that the AAM passed through up to the predetermined point of time during the AAM's operation.

11. An apparatus for monitoring trajectory conformance, comprising:
a memory storing trajectory conformance monitoring program for monitoring trajectory conformance of advanced air mobility (AAM); and
a processor configured to control the memory,
wherein the processor configured to:
obtain information on scheduled airspace segments through which the AAM is scheduled to pass, among a plurality of airspace segments within airways based on a flight plan of the AAM;
obtain information on actual operating segments through which the AMM actually passed, among the plurality of airspace segments based on a flight path of the AAM; and
monitor the trajectory conformance by comparing the information on actual operating segments with the information on the scheduled airspace segments.

12. A non-transitory computer-readable recording medium storing a computer program, wherein the computer program, when executed by a processor, includes instructions that cause the processor to perform a method for monitoring trajectory conformance of advanced air mobility (AAM) comprising:
obtaining information on scheduled airspace segments through which the AAM is scheduled to pass, selected among a plurality of airspace segments within airways based on a flight plan of the AAM; and
obtaining information on actual operating segments through which the AAM actually passed, determined among the plurality of airspace segments based on a flight path of the AAM, and monitoring trajectory conformance of the AAM by comparing the information on the actual operating segments with the information on the scheduled airspace segments.
